(19) United States
(12) Patent Application Publication
(10) Pub. No.: US 2014/0330914 A1
(43) Pub. Date: Nov. 6, 2014

(54) SUPPORTING MULTIPLE FACETS OF USERS IN A SOCIAL NETWORKING SERVICE

(71) Applicant: ITTIAM SYSTEMS PTE. LTD., Singapore (SG)

(72) Inventors: Sattam Dasgupta, Bangalore (IN); Anil Kumar Agara Venkatesha Rao, Bangalore (IN)

(73) Assignee: ITTIAM SYSTEMS PTE. LTD., Singapore (SG)

(21) Appl. No.: 14/270,375

(22) Filed: May 6, 2014

(30) Foreign Application Priority Data
May 6, 2013 (IN) 2025/CHE/2013

(51) Int. Cl. H04L 12/58

(52) U.S. Cl. CPC H04L 51/32
USPC 709/206; 709/225

(57) ABSTRACT

A system and method for supporting multiple facets of users in a social networking service (SNS). In one embodiment, a request is received from a first user to create multiple facets upon logging into the SNS. Each of the multiple facets of the first user is associated with one of social networks within the SNS. Further, profile information associated with each of the multiple facets is received. Furthermore, the profile information of each of the multiple facets is associated to corresponding one of the social networks.

Benefit is claimed under 35 U.S.C. 119(a) to Indian Provisional Patent Application Ser. No 2025/CHE/2013 entitled “MULTIPLE IDENTITY SUPPORT IN SOCIAL NETWORKS” by ITTIAM SYSTEMS PTE. LTD. filed on May 6, 2013.

### FIELD OF TECHNOLOGY

Embodiments of the present invention relate to a social networking service (SNS). More particularly, embodiments of the present invention relate to supporting multiple facets of users in the SNS.

### BACKGROUND

Typically, social networking is a growing means of connecting with people globally. Generally, different social networking services (SNSs) focus on different aspects of people's life and, therefore, may have different networks of people and functionality relevant to the network. Users of the SNSs may also prefer to keep the networks separate from each other. For example, Facebook™ is targeted towards social life and related friends. Further, LinkedIn™ is targeted towards the professional life and related people. For the user of the SNSs, it may be neither convenient nor meaningful to mix different networks. Consequently, people may end up not only using different SNSs but also may end up in maintaining different profiles and networks. Also, users cannot leverage the strengths of one SNS for the network that the SNS is not targeted for.

### BRIEF DESCRIPTION OF THE DRAWINGS

Embodiments of the present invention are illustrated by way of an example and not limited to the figures of the accompanying drawings, in which like references indicate similar elements and in which:

FIG. 1 illustrates a block diagram of a system for supporting multiple facets of users in a social networking service (SNS), according to one embodiment;

FIG. 2 is a block diagram illustrating some components of a multiple facet social networking module, such as the one shown in FIG. 1, according to one embodiment;

FIG. 3 is a table showing exemplary profile information associated with each of multiple facets of a user's identity in the SNS, according to one embodiment;

FIG. 4 is a table showing exemplary social networks of users in the SNS, according to one embodiment;

FIG. 5 illustrates an exemplary interface of the SNS, according to one embodiment; and

FIG. 6 illustrates a flow diagram of an example method for supporting multiple facets of users in a SNS, according to one embodiment.

Other features of the present embodiments will be apparent from the accompanying drawings and from the detailed description that follows.

### DETAILED DESCRIPTION

A system and method for supporting multiple facets of users in a social networking service (SNS) are disclosed. In the following detailed description of the embodiments of the invention, reference is made to the accompanying drawings that form a part hereof, and in which are shown, by way of illustration, specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

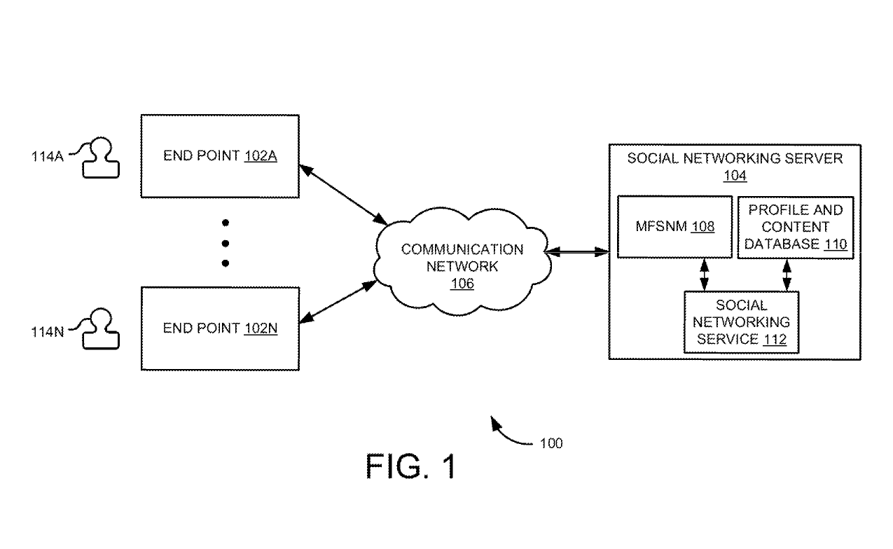

FIG. 1 illustrates a block diagram of a system 100 for supporting multiple facets of users in a social networking service (SNS) 112, according to one embodiment. As shown in FIG. 1, the system 100 includes multiple end points 102A-N associated with multiple users 114A-N. For example, the end points 102A-N include a tablet, a mobile device, a personal computer (PC), and the like. Further, the system 100 includes a social networking server 104 communicatively coupled to the end points 102A-N via a communication network 106. Furthermore, the social networking server 104 includes a multiple facet social networking module (MFSNM) 108, a profile and content database 110 and the SNS 112. The social networking server 104 provides the SNS 112 to build social networks and/or social relations among the users 114A-N. For example, social networks include a professional network, a family network, a friend network and the like. Also as shown in FIG. 1, the SNS 112 is communicatively coupled to the MFSNM 108 and profile and content database 110.

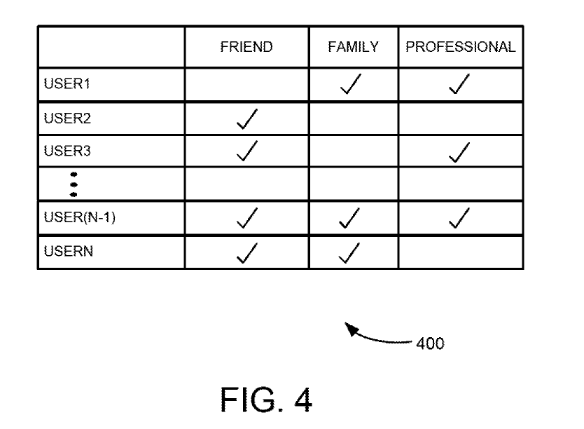

In an example operation, the MFSNM 108 receives a request from a user associated with one of the end points 102A-N (e.g., the user 114A associated with the end point 102A) to create multiple facets upon logging into the SNS 112. In the example illustrated in FIG. 1, each facet of the user 1 14A is associated with one of social networks within the SNS. Each facet of a user can be a friend, a parent, an employee and the like. For example, the facets can be user defined facets or pre-defined facets provided by the MFSNM 108. In this example, the MFSNM 108 allows the user 114A to create facets or select pre-defined facets in the SNS 112. FIG. 4 illustrates an exemplary table 400 showing 3 social networks for 3 different facets of users in the SNS 112. Each of the social networks is associated with a facet defined for a friend, a family member, an employee and the like.

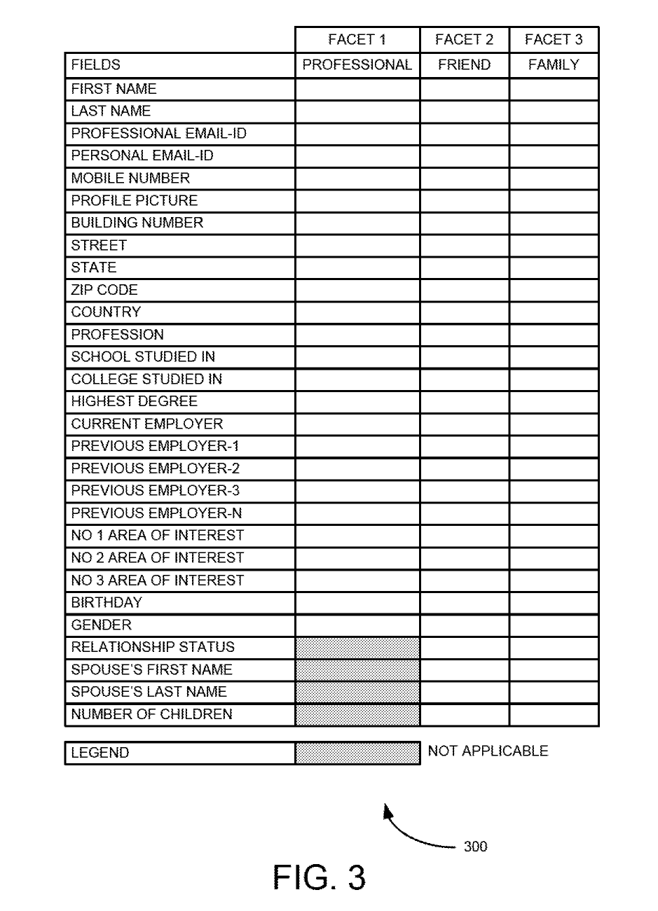

Further in operation, the MFSNM 108 receives profile information associated with each facet of the user 114A. FIG. 3 is an example table 300 showing exemplary profile information associated with each of multiple facets of a user's identity (ID) in the SNS 112. Example profile information provided by a user in the SNS 112 includes first name, last name, mobile number, company name, relationship status, spouse, children and the like. Profile information of the user 114A can be different and specific to each of the facets. For example, details of spouse and children may be related to friend and/or family networks but may not be related professional network. Furthermore, the MFSNM 108 stores the profile information of the user 114A along with the multiple facets in the profile and content database 110.

In addition, the MFSNM 108 associates the profile information of each facet to a corresponding one of the social networks. Moreover, the MFSNM 108 organizes the profile information of the multiple facets into multiple views. Further, the MFSNM 108 displays the profile information in the form of multiple views associated with the social networks within the SNS. The profile information in each of the multiple views is associated with one of the social networks.

Furthermore, the MFSNM 108 allows the user 114A to add other user (e.g., the user 114N associated with the end point 102N) of the SNS in a social network associated with one of the facets based on relationship with the user 114N. For example, relationship can be assigned by a user when requesting or accepting to join other user's social network. In one example, one or more of users can be common across one or more user's social networks.

The users 114A and 114N are then able to view each other's profile information associated with the social network to which the user 114N is added. In one example, the MFSNM 108 shares the profile information of the user 114A with the user 114N based on the relationship with the user 114N. For example, a user can have friends, acquaintances and followers in a friend network. The friends are a group of people who are part of the user's friend network and share a relationship with specific privileges. Further, the acquaintances are a group of people who are part of the user's friend network and share a relationship with limited privileges compared to the friends. Furthermore, the followers are a group of people who are part of the user's friend network and share a relationship with limited privileges compared to the acquaintances.

Also in operation, the MFSNM 108 allows the user 114A to share content or information to the user 114N added in the social network. In one embodiment, the MFSNM 108 stores the content or information, such as images, videos, audios and the like that is shared by the user 114A along with the corresponding facet in the profile and content database 110. Moreover, the MFSNM 108 manages comments, ratings and other qualifiers sent by the user 114N in the associated social network in response to the content or information shared by the user 114A. In addition, the MFSNM 108 allows the user 114A to chat with the user 114N in the associated social network using multiple methods, such as text, voice, video and the like. In some embodiments, the MFSNM 108 tracks online presence and status of the user 114A and shares the tracked information with the user 114N in the associated social network. In one embodiment, the MFSNM 108 stores the comments, ratings and other qualifiers, tracked information and the like in the profile and content database 110.

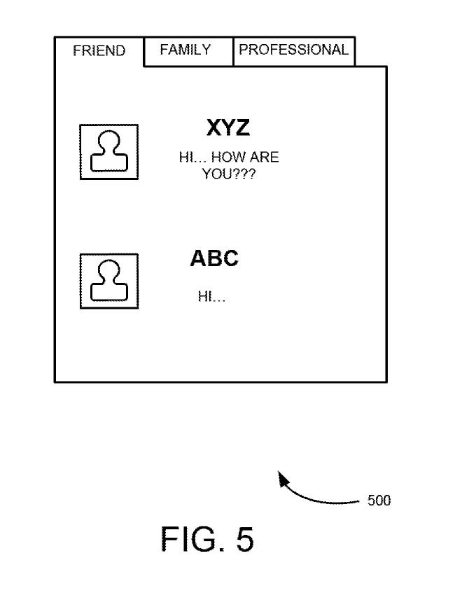

In one example implementation, the MFSNM 108 categorizes and segregates an interface and underlying interactions between the users 114A and 114N within the social networks depending on the user's facet chosen and the associated social network. The MFSNM 108 then enables the user 114A to separately view and interact with the different social networks using the SNS 112 and may have a common login ID and password. FIG. 5 shows an exemplary interface 500 of the SNS 112. The MFSNM 108 organizes all information, functionalities and the like for the social networks associated with the facets into separate views with associated tabs. For a selected tab, all the features and functions displayed are related to only the social network associated with the facet. For example, a comment made by a user1 to a user2 from a friend network (i.e., while in friend tab/view) is visible to the user2 only in the friend tab/view. The user2 cannot see the comment when the user2 is in family tab/view. If a user3 is both in professional and friend networks of the user1 (as shown in table 400 of FIG. 4), then content shared by the user1 while in the professional tab is visible to the user3 when the user3 is in the professional tab.

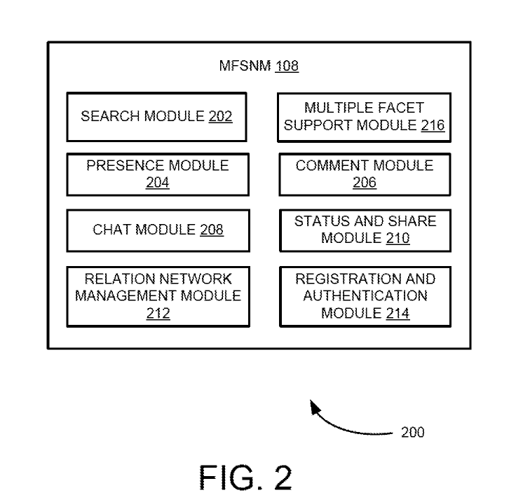

Referring now to FIG. 2, which is a block diagram 200 illustrating some components of the MFSNM 108, such as the one shown in FIG. 1, according to one embodiment. As shown in FIG. 2, the MFSNM 108 includes a search module 202, a presence module 204, a comment module 206, a chat module 208, a status and share module 210, a relation network management module 212, a registration and authentication module 214, and a multiple facet support module 216.

In one embodiment, the registration and authentication module 214 manages registration of a new user and performs authentication on an ID of the new user. Further, the multiple facet support module 216 receives a request from a first user (e.g., the user 114A associated with the end point 102A in FIG. 1) to create multiple facets upon logging into a SNS (e.g., the SNS 112 shown in FIG. 1). Each of the facets is associated with one of social networks within the SNS. Furthermore, the multiple facet support module 216 receives the profile information associated with each of the facets of the first user. In addition, the multiple facet support module 216 associates the profile information of each of the facets to corresponding one of the social networks. In some embodiments, the multiple facet support module 216 organizes the profile information of the facets into multiple views. In these embodiments, the profile information in each of the multiple views is associated with one of the social networks. Moreover, the multiple facet support module 216 allows the first user to add a second user (e.g., the user 114N associated with the end point 102N) of the SNS in a social network associated with one of the facets based on relationship with the second user.

Further, the relation network management module 212 manages the multiple social networks and the corresponding relationship information of all the users within each of the social networks. Furthermore, the status and share module 210 handles the user's status messages specific to a facet and content and/or information shared to the corresponding social network. In addition, the comment module 206 manages comments sent by the second user in the one of the social networks in response to the shared content or information and/or status update from the first user with a specific facet. Also, the search module 202 provides the users' ability to search across the profile and content database 110 including profile information, facets, contents, comments, timelines and the like, depending on authorization. Further, the presence module 204 tracks the online presence and status of the first user for a specific facet and shares the tracked information with the corresponding user's network when allowed by the respective users. Furthermore, the chat module 208 enables chat, between two or more of users with a common facet in the corresponding social network. This is explained in more detail with reference to FIG. 1.

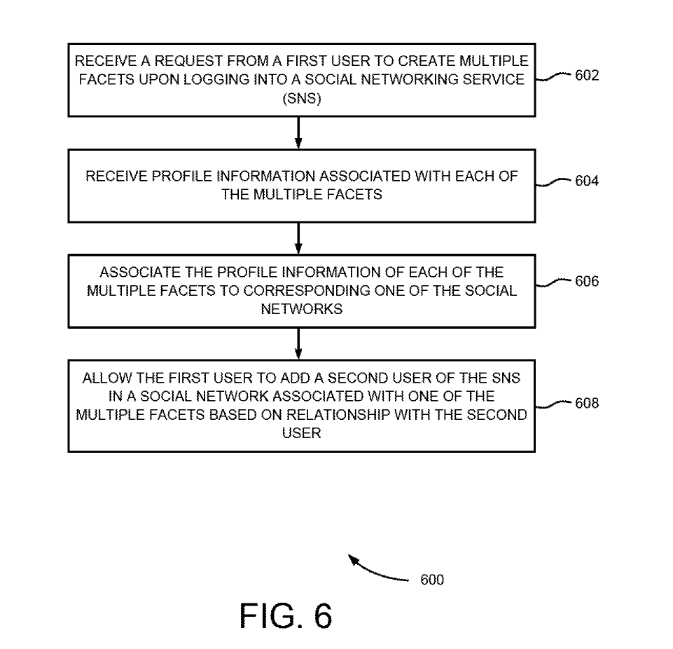

FIG. 6 illustrates a flow diagram 600 of an example method for supporting multiple facets of users in a SNS, according to one embodiment. At block 602, a request is received from a first user to create multiple facets upon logging into the SNS. Each of the multiple facets is associated with one of social networks within the SNS. At block 604, profile information associated with each of the multiple facets is received. At block 606, the profile information of each of the multiple facets is associated to corresponding one of the social networks. In some embodiments, the profile information of the multiple facets is then organized into multiple views. Further, the profile information is displayed in the form of multiple views associated with the social networks within the SNS. In these embodiments, the profile information in each of the multiple views is associated with one of the social networks.

At block 608, the first user is allowed to add a second user of the SNS in a social network associated with one of the multiple facets based on relationship with the second user. The first user and the second user are able to view each other's profile information associated with the social network to which the second user is added. Further, the first user is allowed to share content or information to the second user added in the social network. Furthermore, comments, ratings and other qualifiers sent by the second user in the associated social network in response to the content or information shared by the first user are managed. In addition, online presence and status of the first user is tracked and the tracked information is shared with the second user in the associated social network. Moreover, the first user is allowed to chat with the second user in the associated social network using multiple methods, such as text, voice, video and the like. This is explained in more detail with reference to FIGS. 1-5.

In one embodiment, an article comprising a non-transitory computer readable storage medium having instructions thereon which when executed by a computing platform result in execution of the above mentioned method. The method described in the foregoing may be in a form of a machine-readable medium embodying a set of instructions that, when executed by a machine, causes the machine to perform any method disclosed herein. It will be appreciated that the various embodiments discussed herein may not be the same embodiment, and may be grouped into various other embodiments not explicitly disclosed herein.

In various embodiments, the systems and methods described in FIGS. 1 through 6 propose a technique for supporting multiple facets of users in a SNS. In other words, for a single user within the SNS, the technique of having multiple user facets and multiple corresponding social networks with an ability to have one or more of users common across two or more of the social networks and yet keeping the social networks separate is proposed. Thus, the user can use the functionalities and features offered by the SNS across the different networks of users that one has to interact with and keep the social networks independent of each other.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
receiving a request from a first user to create multiple facets upon logging into a social networking service (SNS), wherein each of the multiple facets of the first user is associated with one of social networks within the SNS;
receiving profile information associated with each of the multiple facets; and
associating the profile information of each of the multiple facets to corresponding one of the social networks.

2. The method of claim 1, further comprising:
organizing the profile information of the multiple facets into multiple views; and
displaying the profile information in the form of multiple views associated with the social networks within the SNS, wherein the profile information in each of the multiple views is associated with one of the social networks.

3. The method of claim 1, further comprising:
allowing the first user to add a second user of the SNS in a social network associated with one of the multiple facets based on relationship with the second user, wherein the first user and the second user are able to view each other's profile information associated with the social network to which the second user is added.

4. The method of claim 3, further comprising;
allowing the first user to share content or information to the second user added in the social network.

5. The method of claim 4, further comprising:
managing comments, ratings and other qualifiers sent by the second user in the associated social network in response to the content or information shared by the first user.

6. The method of claim 3, further comprising:
tracking online presence and status of the first user and sharing the tracked information with the second user in the associated social network.

7. The method of claim 3, further comprising:
allowing the first user to chat with the second user in the associated social network.

8. A system, comprising:
multiple end points associated with multiple users; and
a social networking server communicatively coupled to the multiple end points via a communication network, wherein the social networking server comprises a multiple facet social networking module (MFSNM) to:
receive a request from a first user to create multiple facets upon logging into a social networking service (SNS), wherein each of the multiple facets of the first user is associated with one of social networks within the SNS;
receive profile information associated with each of the multiple facets; and
associate the profile information of each of the multiple facets to corresponding one of the social networks.

9. The system of claim 8, wherein the MISNM is further configured to:
organize the profile information of the multiple facets into multiple views; and
display the profile information in the form of multiple views associated with the social networks within the SNS, wherein the profile information in each of the multiple views is associated with one of the social networks.

10. The system of claim 8, wherein the MISNM is further configured to:
allow the first user to add a second user of the SNS in a social network associated with one of the multiple facets based on relationship with the second user, wherein the first user and the second user are able to view each other's profile information of associated with the social network to which the second user is added.

11. The system of claim 10, wherein the MISNM is further configured to:
allow the first user to share content or information to the second user added in the social network.

12. The system of claim 11, wherein the MISNM is further configured to:
manage comments, ratings and other qualifiers sent by the second user in the associated social network in response to the content or information shared by the first user.

13. The system of claim 10, wherein the MISNM is further configured to:
track online presence and status of the first user and share the tracked information with the second user in the associated social network.

14. The system of claim 10, wherein the MISNM is further configured to:
allow the first user to chat with the second user in the associated social network.

15. A non-transitory computer-readable storage medium including instructions that are configured, when executed by a computing device, to perform a method of supporting multiple facets of users in a social networking service (SNS), the method comprising:
receiving a request from a first user to create multiple facets upon logging into the SNS, wherein each of the multiple facets of the first user is associated with one of social networks within the SNS;
receiving profile information associated with each of the multiple facets; and
associating the profile information of each of the multiple facets to corresponding one of the social networks.

16. The non-transitory computer-readable storage medium of claim 15, further comprising:
organizing the profile information of the multiple facets into multiple views; and
displaying the profile information in the form of multiple views associated with the social networks within the SNS, wherein the profile information in each of the multiple views is associated with one of the social networks.

17. The non-transitory computer-readable storage medium of claim 15, further comprising:
allowing the first user to add a second user of the SNS in a social network associated with one of the multiple facets based on relationship with the second user, wherein the first user and the second user are able to view each other's profile information associated with the social network to which the second user is added.

18. The non-transitory computer-readable storage medium of claim 17, further comprising:
allowing the first user to share content or information to the second user added in the social network.

19. The non-transitory computer-readable storage medium of claim 18, further comprising:
managing comments, ratings and other qualifiers sent by the second user in the associated social network in response to the content or information shared by the first user.

20. The non-transitory computer-readable storage medium of claim 17, further comprising:
tracking online presence and status of the first user and sharing the tracked information with the second user in the associated social network.

21. The non-transitory computer-readable storage medium of claim 17, further comprising:
allowing the first user to chat with the second user in the associated social network.
